(19) United States
(12) Patent Application Publication
(10) Pub. No.: US 2012/0329678 A1
(43) Pub. Date: Dec. 27, 2012

(54) Method for Making Mate-Pair Libraries

(75) Inventors: Feng Chen, Castro Valley, CA (US); Ze Peng, Moraga, CA (US); Zhiying Zhao, Danville, CA (US); Nandita Nath, Fremont, CA (US); Jeff L. Froula, Walnut Creek, CA (US)

(73) Assignee: THE REGENTS OF THE UNIVERSITY OF CALIFORNIA, Oakland, CA (US)

(21) Appl. No.: 13/535,167

(22) Filed: Jun. 27, 2012

Related U.S. Application Data
(60) Provisional application No. 61/501,402, filed on Jun. 27, 2011.

(51) Int. Cl. C40B 50/06; C40B 40/06

(52) U.S. Cl. 506/16; 506/26

(57) ABSTRACT

The present disclosure provides methods for generating mate-pair libraries using a recombinase/recombination site system. The method allows for increased insert size, improved efficiency and simplicity of the steps involved, and improved data generation. Mate-pair libraries are helpful in providing positional information for the assembly of sequence data from short read sequencing platforms. The disclosure also embodies the mate-pair libraries as generated from these methods.

### CROSS-REFERENCE TO RELATED APPLICATIONS

This application claims priority to U.S. Provisional Application Ser. No. 61/501,402, filed Jun. 27, 2011, which is hereby incorporated by reference.

### STATEMENT OF GOVERNMENTAL SUPPORT

The invention described and claimed herein was supported by Contract No. DE-AC02-05CH11231 awarded by the U.S. Department of Energy under. The government has certain rights in the invention.

### REFERENCE TO A SEQUENCE LISTING SUBMITTED AS A TEXT FILE VIA EFS-WEB

The official copy of the sequence listing is submitted concurrently with the specification as a text file via EFS-Web, in compliance with the American Standard Code for Information Interchange (ASCII), with a file name of “IB2944_SeqListing.txt”, a creation date of Jun. 20, 2012, and a size of 3 KB. The sequence listing filed via EFS-Web is part of the specification and is hereby incorporated in its entirety by reference herein.

### BACKGROUND OF THE INVENTION

There are many methods of high throughput sequencing technologies that result in extremely high numbers of relatively short stretches of DNA being sequenced, e.g., the SOLiD™ sequencing system sold by Applied Biosystems or the Genome Analyzer sold by Illumina. One method of extracting more information from such short DNA sequences is to use mate-pair sequence tags, wherein the approximate distance between the mate-pair sequences on the genome is known. Each pair of sequence tags is derived from a single DNA fragment. Such genomic fragments used to generate mate-pairs are typically of a length within a pre-determined range of possible lengths, such as, for example 2-3 kb. This positional information provided by mate-pair sequence tags can be used to help assemble the large amount of sequence data from short read sequencing platform and to resolve structural variations in genomes. However, currently available methods for building such libraries have one or more limitations, such as relatively small insert size; unable to distinguish the junction of two ends; and/or low throughput. Thus, there is a need for methods of making mate-pair libraries that can overcome these limitations.

### BRIEF SUMMARY OF THE INVENTION

The present invention provides for a method for making a mate-pair library. In some embodiments, the method comprises the following steps: (a) fragmenting target DNA, thereby generating fragmented target DNA fragments; (b) size-selecting the fragmented target DNA, thereby generating size-selected DNA; (c) ligating a forward adaptor oligonucleotide and a reverse adaptor oligonucleotide to the size-selected DNA, wherein the forward adaptor oligonucleotide comprises a recombinase recombination site and a forward primer binding site and the reverse adaptor oligonucleotide comprises a recombinase recombination site and a reverse primer binding site, thereby generating adaptor-ligated size-selected DNA comprising ligated adaptor oligonucleotides at both ends of the fragments, wherein: the recombinase recombination site in the forward adaptor oligonucleotide, when ligated to the size-selected DNA, is distal to the size-selected DNA relative to the forward primer binding site; the recombinase recombination site in the reverse adaptor oligonucleotide, when ligated to the size-selected DNA, is distal to the size-selected DNA relative to the reverse primer binding site; the recombinase recombination sites are oriented in the adaptor-ligated size-selected DNA such that, when contacted with a recombinase, one of the recombinase recombination sites is excised and the adaptor-ligated size-selected DNA is circularized; and the primer binding sites are oriented in the adaptor-ligated sized-selected DNA such that, after recombination, second fragmentation and recircularization, the forward and reverse primer binding sites are oriented toward each other so the amplification can occur; (d) removing the nick between DNA fragment and adapter; (e) contacting the adaptor-ligated size-selected DNA with the recombinase to form circularized DNA comprising the forward and reverse primer sites in opposing directions and separated by a recombinase recognition/recombination site; (f) removing non-circularized DNA from the circularized DNA or digesting the non-circularized DNA; (g) fragmenting the circularized DNA, thereby generating linear DNA fragments comprising the forward and reverse primer sites in opposing directions flanked by target DNA; (h) self-ligating the linear DNA fragments, thereby forming re-circularized DNA comprising the forward and reverse primer sites; and (i) amplifying the re-circularized DNA with the forward and reverse primer, thereby forming a mate-pair library.

In some embodiments, the recombinase is a Cre recombinase and the recombinase recombination sites are lox sites.

In some embodiments, the fragmenting (step g) comprises cutting the circularized DNA with a restriction enzyme. In some embodiments, the recognition sequence of the restriction enzyme is four contiguous base pairs.

In some embodiments, the fragmenting (step g) comprises random shearing. In some embodiments, ends of the linear DNA fragments generated in step f are treated to generate blunt ends.

In some embodiments, the amplifying (step i) comprises a polymerase chain reaction (PCR).

In some embodiments, the method further comprises sequencing the mate-pair library. In some embodiments, the method further comprises sequence assembly from data generated from sequencing. In some embodiments, the fragmenting (step g) comprises cutting the circularized DNA with a restriction enzyme, and the step before assembly comprises determining the location of the recognition sequence of the restriction enzyme.

In some embodiments, following the fragmenting (step a), and before the ligating (step c), ends of the fragmented target DNA are treated to generate blunt ends.

In some embodiments, the target DNA is genomic DNA.

In some embodiments, the fragmented target DNA is size-selected for DNA between 2-5 kb. In some embodiment, the fragmented target DNA is size-selected for DNA between 8-12 kb. In some embodiment, the fragmented target DNA is size-selected for DNA between 15-25 kb.

In some embodiments, the fragmented target DNA is size-selected for DNA in a range with upper size limit of 90 kb.

The present invention also provides for a mate-pair library as generated by the methods detailed above or as described elsewhere herein.

In some embodiments, the mate-pair library is generated by a method including cutting the circularized DNA with one or more restriction enzymes such that the member (e.g., each member) of the library comprises one or more recognition sequences of the restriction enzymes.

The present invention also provides for kits for performing the methods described herein.

### BRIEF DESCRIPTION OF THE DRAWINGS

FIG. 1: A schematic representation of the CLIP-PE library construction strategy

FIG. 2: Histogram of insert sizes from Haloterrigena turkmenica VKM, DSM 5511 5 kb Mate-pair libraries made by (a) CLIP-PE method and (b), Illumina jumping method. The distribution of insert lengths was determined by aligning the reads to the reference genome.

FIG. 3: Histogram of insert sizes from Saccharomyces cerevisiae Illumina 12 kb CLIP-PE libraries. The distribution of insert lengths was determined by aligning the reads to the reference genome.

FIG. 4: Histogram of insert sizes from Saccharomyces cerevisiae Illumina 22 kb CLIP-PE libraries: (a) NlaIII cutting approach, (b) HpyCh41V cutting approach, (c) random shearing approach. The distribution of insert lengths was determined by aligning the reads to the reference genome.

FIG. 5: Assembly metrics for Saccharomyces cerevisiae Illumina CLIP-PE libraries. Sim Std refers to simulated standard Illumina 250 bp library. Sim12 kb refers to simulated 12 kb Mate-pair library. Sim22 kb refers to simulated 22 kb Mate-pair library.

### DETAILED DESCRIPTION OF THE PREFERRED EMBODIMENTS

### Definitions

As used herein, the term “mate-pair library” refers to a collection of nucleic acid sequences, wherein the nucleic acid sequences are made up of the ends of long nucleic acid sequences whose middle portion have been removed. Mate-pairs can be generated, for example, by circularizing fragments of nucleic acids with an internal adapter construct, removing the middle portion of the nucleic acid fragment, and subsequently generating a nucleic acid molecule that comprises the remaining fragment ends, i.e., the “mate-pair.” In some embodiments, the removed middle section, as well as the average size of the original long nucleic acid fragment, allows one to predict a known or expected distance between the remaining ends of the mate-pair. In some embodiments, there are tens of millions or more different unique members of the mate-pair library.

As used herein, with reference to primers, the terms “forward” and “reverse” refer to pairs of primers capable of generating an amplicon with reference to a specified template sequence. The terms “forward” and “reverse” do not necessarily indicate position and are merely used to distinguish one from the other.

As used herein, the term “distal” site refers to a site that is farther away from a specified location, compared to another site. For example, in the series A-B-C, “A” is distal to B, relative to C.

As used herein, the term “circularized” DNA refers to DNA generated by linking the two ends of a DNA fragment to each other.

As used herein, “primer sites” are said to be in “opposing directions” when hybridizing primers prime extensions in directions away from each other (e.g., ← →).

As used herein, the term “recombinase” refers to a protein involved in recombination. As such recombinases recognize and bind two specific DNA sequences termed “recombination sites” or “target sites” and mediate recombination between these two target sites. Accordingly, the term “recombinase” is meant to refer to any protein component of any recombinant system that mediates DNA rearrangements in a specific DNA locus. Naturally occurring recombinases recognize symmetric target sites consisting of two identical sequences termed “half-site” of approximately 9-20 bp forming an inverted repeat, wherein the half-site sequences are separated by a spacer sequence of 5-12 bp. Recombinases include, for example, Cre recombinase, Hin recombinase, RecA, RAD51, Tre, and FLP. Cre recombinase is a Type I topoisomerase from P1 bacteriophage that catalyzes site-specific recombination of DNA between loxP sites. This invention uses Cre or any other site-specific recombinases.

In some embodiments, the recombinase is the Cre recombinase, recognizing a symmetric target site of 34 bp known as loxP. The loxP site is palindromic with two 13 bp repeats separated by the eight innermost base pairs, which represent the so-called spacer, which imparts directionality to the site. Recombination takes place by cleavage within the spacer sequence. Depending on the relative location and orientation of the two participating loxP sites, Cre catalyses DNA integration, excision or rearrangement. The Cre recombinase also recognizes a number of variant or mutant lox sites relative to the loxP sequence. Examples of these Cre recombination sites include, but are not limited to, the loxB, loxL, loxR, loxP3, loxP23, loxΔ86, loxΔ117, loxP511, and loxC2 sites.

As used herein, the term “recombination sites” refers to discrete sections or segments of DNA on the participating nucleic acid molecules that are recognized and bound by a site-specific recombination protein during the initial stages of integration or recombination. For example, the recombination site for Cre recombinase is loxP (or other lox sites as discussed above), which is a 34 base pair sequence comprised of two 13 base pair inverted repeats (serving as the recombinase binding sites) flanking an 8 base pair core sequence.

### I. Introduction

In one embodiment, herein is described methods for the generation of improved mate pair libraries for nucleotide sequencing. In some embodiments, benefits of the method include increased insert size, improved efficiency and simplicity of the steps involved, and improved data generation due to ready identification of end junctions.

In some embodiments, methods for generating improved mate-pair libraries can include a recombinase and recombination sites in the mate-pair generation method. Inclusion of recombination sites and the recombinase allows for efficient circularization of DNA fragments, optionally over larger fragment sizes (e.g., >20 kb, and up to 90 kb.) compared to standard mate-pair library generation in which initial fragments are more commonly 3-5 kb (though smaller fragments, including those between 3-5 kb can also be generated with the method of the invention, if desired).

In other embodiments, methods for generating improved mate-pair libraries can include an inverse PCR approach to amplify and enrich desired recombined DNA fragments. PCR primer binding sites are incorporated in adaptors used in the first ligation step and are oriented such that, after recombination, second fragmentation and recircularization, the forward and reverse primer binding sites are oriented toward each other so the amplification can occur.

In addition, the inventors have found that use a restriction enzyme (rather than random cutting or shearing as described in the prior part) to cleave the circularized DNA allows for improved efficiency of the process and notably, allows one to later readily identify the exact location of ends in the sequencing, thereby allowing, for example, for improved sequence data analysis.

### II. Generation of Mate-Pair Libraries

The starting material can be any source of nucleic acid desired to be sequenced. The nucleic acids can be, e.g., genomic DNA from any species, including but not limited to humans, non-human mammals (e.g., mice, rats, primates, etc.), other animals, plants, fungi, bacteria or viruses. In some embodiments, the nucleic acid sequences are synthetic sequences.

Initially, the source DNA is fragmented. For example, in some embodiments, the genomic DNA is sheared or randomly fragmented to an average size fragment as desired.

The resulting fragments are then end-repaired. End-repair involves generating blunt ends on the fragments that are amenable to ligation. In some embodiments, the end-repair comprises, e.g., treating the ends with one or more polymerases to remove 3′ overhangs and/or to fill in 5′ overhangs. In some embodiments, the polymerase(s) includes, e.g., T4 DNA polymerase and/or E. coli DNA polymerase I Klenow fragment. The 3′ to 5′ exonuclease activity of these enzymes removes 3′ overhangs and fills in the 5′ overhangs, leaving a 5′ phosphorylated end. In some embodiments, DNA kinase such as T4 Polynucleotide Kinase was used to add 5′-phosphates to oligonucleotides to allow subsequent ligation

Prior to end-repair, or after end-repair, the fragments can be size-selected. Size-selection can be achieved, for example, using gel electrophoresis. Depending on the size of the fragments, it can be desirable to use regular gel electrophoresis or pulse-field gel electrophoresis (PFGE) or other separation technology that minimizes additional fragmentation. As noted above, one advantage of the present invention is that fragments of greater size can be used. Thus, in some embodiments, the fragments are size-selected to have an average size of 5 kb, 8 kb, 10 kb, 20 kb, 30 kb, etc. Other size fragments can be selected as desired.

Adaptors can be ligated or otherwise linked to the size-selected and end-repaired fragments. The adaptors comprise a recombinase recombination site as well as a primer binding site (i.e., primer hybridization site). Generally, at least two different adaptors are used. For example, in some embodiments, a forward adaptor oligonucleotide, comprising a recombinase recombination site and a forward primer binding site; and a reverse adaptor oligonucleotide, comprising a recombinase recombination site and a reverse primer binding site, are used. The recombinase recombination sites and primer binding sites are oriented in the adaptor oligonucleotides such that when the forward adaptor oligonucleotide and the reverse adaptor oligonucleotide are ligated to alternate ends of the same fragment, the recombinase recombination sites allow for circularization in the presence of recombinase activity. The recombinase recombination sites and the primer binding sites are oriented in the adaptor oligonucleotides such that, after recombination, second fragmentation and recircularization, the forward and reverse primer binding sites are oriented toward each other so the amplification can occur.

After ligation, the nicks present at the junction site of the end repaired fragment and adaptors can be removed. For example, the nicks can be removed by a strand displacement DNA polymerase, e.g., such as Bst DNA polymerase, which has 5′→3′ polymerase and double-strand specific 5′→3′ exonuclease activity, but lacks 3′→5′ exonuclease activity.

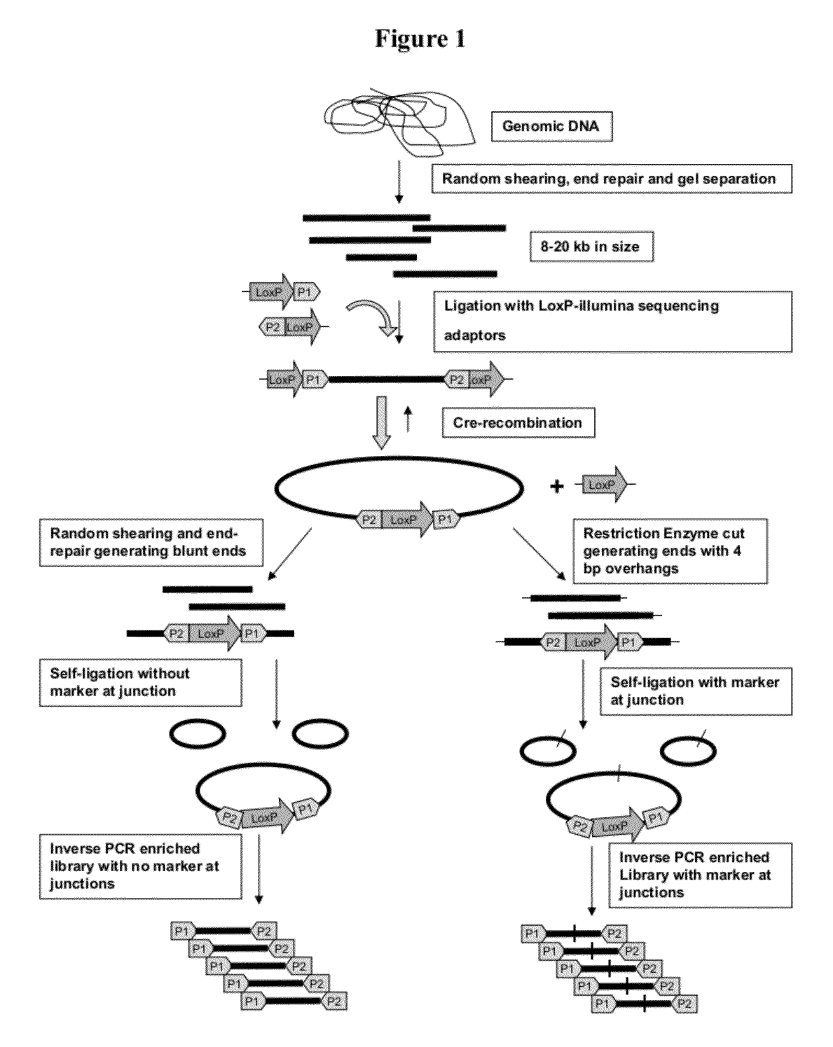

Site-specific recombinases catalyze a recombination reaction between two site-specific recombination sequences depending on the orientation of the site-specific recombination sequences. Sequences intervening between two site-specific recombination sites will be inverted in the presence of the site-specific recombinase when the site-specific recombination sequences are oriented in opposite directions relative to one another (i.e. inverted repeats). This aspect is not used in the present invention. If the site-specific recombination sequences are oriented in the same direction relative to one another (i.e. direct repeats), then the intervening sequences will be circularized upon interaction with the site-specific recombinase. Thus, if the site-specific recombination sequences are present as direct repeats at both ends of an adaptor-ligated fragment, the fragment can subsequently be circularized by interaction of the site-specific recombination sequences with the corresponding site-specific recombinase. See FIG. 1.

Exemplary recombinase/recombination site systems useful in some embodiments include but are not limited to the Cre/lox or FLP/FRT systems. Lox sites are said to be “oriented” with respect to each other. The orientation and location of the loxP sites determine whether Cre recombination induces a deletion (circularization), inversion, or chromosomal translocation. See, Nagy A., Genesis 26:99-109 (2000). A number of lox site sequences have been identified. Thus, in some embodiments, the lox sites are selected from, loxB, loxL, loxR, loxP3, loxP23, loxΔ86, loxΔ117, loxP511, or loxC2 sites.

Following linking of the adaptors to the fragments, the fragments are contacted with the recombinase, thereby circularizing fragments linked to the appropriately oriented adaptors. See, FIG. 1. Depending on the recombinase system, in some embodiments, at least one recombination site, or a portion thereof, is removed during the circularization process, leaving one recombination site in the circularized DNA. In some embodiments, the circularized DNA is subsequently separated (e.g., purified) from non-circularized DNA and/or the non-circularized DNA can be digested, e.g., with a DNase having exonuclease activity but little or no endonuclease activity.

The circularized DNA fragments are subsequently cleaved or sheared to remove a middle portion of the fragments, leaving a linear DNA fragment comprising the forward and reverse primer sites in opposing (outward) directions, and optionally depending on the recombination system used, separated by a recombination site. The linear fragments also include, at each end, the remaining ends of the original fragments. The remaining ends will vary in length depending on precisely where on the circularized DNA the shear or cleavage events occurred. In some embodiments, the remaining ends have about, an average of 256 nucleotides when restriction enzymes recognizing four-base pair sequence are used or random lengths when random shearing is used.

In some embodiments, the circularized DNA is sheared or otherwise randomly fragmented. In these embodiments, the shear or randomly fragmented DNA can be end-repaired as described above such that the fragmented sequences can be self-ligated, thereby generating re-circularized DNA.

Alternatively, instead of shearing or random fragmentation, the circularized fragments can be cleaved by a restriction enzyme. As the goal is for the restriction enzyme to cleave at least twice in the circularized DNA (to cut out a middle portion), in some embodiments, a frequent cutter, such as a restriction enzyme that recognizes four-base pair sequences, is used. Generally, a four base-cutter enzyme is selected such that the restriction enzyme's recognition sequence is not within the primer binding sites and the recombination site. Exemplary four base cutters include, but are not limited to those listed in Table 6 such as, NlaIII, HhaI, and HpyCH4IV. In some embodiments, the restriction enzyme leaves an overhang, thereby facilitating subsequent self-ligation of the remaining fragment. Self-ligation can be achieved using any ligase, such as T4 ligase. The presence of the restriction enzyme recognition site provides an additional benefit of allowing for a precise determination of the point of ligation, thereby defining the boundary of the “left” and “right” ends (“left” and “right” being arbitrary terms to refer to either end). As discussed more below, subsequent sequencing of the mate-pair allows for more information than would be provided from a re-circularization of sheared DNA because the boundaries of the ends in shearing are random and not readily determinable. By defining the boundaries of the ends of the initial fragments, the sequences provide additional information allowing for more efficient generation of scaffolds or other sequencing information.

Following re-circularization, the primer sites will be oriented such that the remaining portion of the re-circularized DNA corresponding to remaining DNA from the initial fragments can be amplified. This is illustrated, for example, in FIG. 1. Any type of amplification is contemplated for the amplification. In some embodiments, the amplification comprises the polymerase chain reaction (PCR). For example, inverse PCR (iPCR) can be used. The amplification results in multiple copies of each mate pair, thereby generating a library of mate-pair sequences bounded by primer binding sites.

The mate-pair library, or at least a portion thereof, can subsequently be sequenced. In some embodiments, by sequencing numerous mate-pair clones, the ends of the fragments can be mapped to a reference sequence or can be used to generate a de novo assembly.

One particular advantage of the present invention is the ability to efficiently circularize the initial fragments, thereby allowing for generation of mate-pairs from considerably larger fragments. Mate-pair sequences from larger fragments are particularly useful in sequencing repetitive DNA. By allowing for larger fragments, the chances of any particular pair of ends both being within a repeat is decreased, thereby allowing for more useful connecting contigs.

Any type of nucleotide sequencing method can be used to determine the sequences of the mate pairs. Two most popular commercial systems available for ultra-high-throughput, massively parallel DNA sequencing include: SOLEXA (Illumina, San Diego, Calif.) and the SOLiD system (Applied BioSystems, Foster City, Calif.). The throughput of these new instruments can exceed billions of bases per run, thousands of folds more than the capillary-electrophoresis-based sequencing technologies and 454 Sciences sequencing-by-synthesis sequencing technology. The use of these new sequencing platforms for characterization of the mate-pairs is considered within the scope and principle of the present invention.

### III. Software and Data Analysis

The mate-pair data generated from the libraries made as described herein can be analyzed according to known methods, including but not limited to those described in US Patent Publication No. 2008/0189049, hereby incorporated by reference. In some embodiments, the methods herein may operate with sequence alignment or DNA assembly algorithms. Sequence alignment is defined as a way of mapping the reads to homologous regions of a reference, when a reference is available. Without a reference, the reads can be assembled de novo. Assembly is defined as aligning and merging reads into a much longer DNA sequence in order to reconstruct the original sequence. Common assemblers are Velvet, ALLPATHS, and Newbler. Before alignment or assembly, sequence reads are trimmed by locating the boundaries of the ends as defined by the restriction enzyme recognition sequence when restriction enzymes are used in library construction.

Mate-pair reads contain positional information of two distant segments of sequence derived from the same DNA molecule. The distance between pairs is known as well as their strand orientation (i.e. pointing inward or outward). This positional information can be used to resolve structural variants in genomes by mapping these two fragments with a distance constraint and orientation constraint. This positional information can also be used in de novo assembly to resolve repetitive elements in genomes and to order and orient contigs to form scaffolds.

The specific details of particular embodiments may be combined in any suitable manner or varied from those shown and described herein without departing from the spirit and scope of embodiments of the invention.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

### IV. Kits

The present invention also provides for kits comprising reagents for practicing the methods described herein. In some embodiments, the kits comprise one or more (and in some embodiments all) of the following: reagents for repairing ends of fragments, including but not limited to DNA polymerases such as T4 polymerase and/or Klenow fragment, T4 polynucleotide kinase, adaptor oligonucleotide(s) (optionally a forward and reverse adaptor oligonucleotide as described herein including recombination and primer binding sites). The kits can also include one or more ligase such as Quick ligase and T4 ligase, strand displacement DNA polymerase such as Bst DNA Polymerase, and a recombinase such as Cre-recombinase. The kits also can comprise one or more DNA exonuclease substantially lacking endonuclease activity for removal of non-circularized (linear), such as Plasmid-Safe™ ATP-Dependent DNase. The kits can also include one or more restriction enzyme, e.g., in some embodiments a four-cutter restriction enzyme, e.g., such as NlaIII and HpyCh4IV. The kits can also include some PCR amplification reagents (such as Phusion® High-Fidelity DNA Polymerase and Deoxynucleotide Solution Mix (dNTP)). Optionally, instructions for use of the kit reagents can be included. The kit can be packaged in one or more container and the individual reagents can be included in separate packaging or can be combined in the same container as appropriate.

### EXAMPLES

The following examples are offered to illustrate, but not to limit the claimed invention.

Large insert mate pair reads have a major impact on the overall success of de novo assembly and the discovery of inherited and acquired structural variants. The positional information of mate pair reads will in general improve the assembly by resolving repeat elements and ordering contigs. The most popular 2^{nd} generation sequencing platform, Illumina, currently has a commercially available mate pair library construction kit with only a recommended insert size of 5 kilobases (kb) and an unknown junction point of two distant ends. We developed a new approach, Cre-LoxP Inverse PCR Paired-End (CLIP-PE), which exploits the advantages of (1) Cre-LoxP recombination system to efficiently circularize large DNA fragments, (2) inverse PCR to enrich for the desired products that contain both ends of the large DNA fragments, and (3) the use of restriction enzymes to improve the self-ligation efficiency and to introduce a recognizable junction site between ligated fragment ends. We have successfully created CLIP-PE libraries up to 22 kb that are rich in informative read pairs and low in small fragment background. These libraries have demonstrated the ability to improve genome assemblies. The CLIP-PE methodology can be implemented with other next-generation sequencing platforms.

De novo assembly of short reads generated by 2^{nd} generation sequencing platforms is a challenging task. Yet mate pair reads are useful for de novo assembly of complex genomes, especially for joining contigs flanking repetitive sequences. They can also be important for the discovery of structural variations, such as, insertions, deletions and inversions (Fullwood, M. J. et al., Genome Research 19, 521-532 (2009)). A variety of methods for constructing genomic DNA (gDNA) mate pair libraries have been developed for different sequencing platforms, each with its own pros and cons. Sanger paired end sequencing (Kelley, J. M. et al., Nucleic Acids Res 27, 1539-46 (1999)) generates long reads of high quality; however, the sequencing process is costly, labor intensive and time consuming. Genomic DNA di-tag is a method derived from SAGE (serial analysis of gene expression), in which 18 or 27 bp paired end tags are extracted from the ends of gDNA inserts by MmeI (Ng, P. et al., Nature Methods 2, 105-111 (2005)) or EcoP15I (Matsumura, H. et al., Proc Natl Acad Sci USA 100, 15718-23 (2003)) enzyme digestion. The resulting genomic fragments are concatenated to long fragments before being sequenced by Sanger or 2^{nd} generation platforms. The disadvantage of the di-tag method is that it produces short reads which may be mapped to multiple locations in complex genomes. Recently, various commercial kits became available for making mate pair libraries on 2^{nd} generation sequencing platforms. The Mate pair library prep kit (downloadable from the Illumina.com/products/mate_pair_library_prep_kit website) offered by Illumina suggests constructing mate pair libraries not more than 5 kb in insert size; furthermore, only the first 36 bp from each of the paired reads are realistically usable since there is no clearly defined boundary in the fragment being sequenced between the paired reads. Sequencing beyond this boundary will result in chimeric reads. The Roche 454 Jump Recombi Paired-end library preparation kit (downloadable from the 454.com/products-solutions/experimental-design-options/multi-span-paired-end-reads website) makes up to 20 kb libraries. The advantage of this method is that longer reads can be obtained and there is a well defined junction site marked by the linker sequence that can be used to differentiate the origin of the reads with high confidence. However, their platform is not cost effective and the throughput is relatively low. More recently, an Illumina 40 kb jumping library was made by cloning 40 kb gDNA in a modified fosmid vector (Gnerre, S. et al., Proc Natl Acad Sci USA 108, 1513-8 (2011)) and extracting paired end sequence tags via nick translation. However, the procedure is clone based resulting in limited library complexity, and the vectors are not commercially available yet.

We report here a novel in vitro method that utilizes the Cre-LoxP recombination system (Hoess, R. H. and Abremski, K., Proceedings of the National Academy of Sciences of the United States of America 81, 1026-1029 (1984); Sternberg, N. and Hamilton, D., Journal of Molecular Biology 150, 467-486 (1981); Sternberg, N., Hamilton, D. and Hoess, R., Journal of Molecular Biology 150, 487-507 (1981)) for making long insert mate-pair libraries. Briefly, randomly sheared genomic DNA (gDNA) fragment ends are ligated with adapters containing LoxP and Illumina P1 or P2 PCR priming sequences. Through Cre recombinase mediated intra-molecule recombination, gDNA fragments are circularized followed by enzymetic fragmentation and self ligation, DNA fragments containing P1-LoxP-P2 sequences are selectively amplified by PCR using Illumina P1 and P2 primers. The amplified products contain the paired end reads and are fully compatible with Illumina's sequencing platform. The CLIP-PE strategy is illustrated in FIG. 1. This method has been used to generate 5 kb, 12 kb, and 22 kb Illumina mate pair libraries. Furthermore, a recognizable junction site has been introduced between read pairs to help demarcate them and to avoid chimeric reads.

CLIP-PE Libraries have a Higher Fraction of Correctly Distanced Mate-Pairs than Illumina Jumping Library

5 kb is the recommended insert size for Illumina's Mate pair kit. We created two 5 kb libraries of Haloterrigena turkmenica VKM, DSM 551 using the CLIP-PE strategy and the Illumina's jumping method in parallel (Table 1). Both libraries were sequenced with the same 2×76 bps protocol using Illumina's Genome Analyzer (GA) IIx. Two criteria were used to measure the quality of a library: (1) the percentage of informative pairs and (2) the percentage of chimeric pairs. Informative pairs are those that have unambiguous mapping coordinates and are only counted once if they were duplicated. Small clonal artifact/contamination can easily be identified when a reference genome is supplied since this will map as read pairs closer to each other than was expected. Chimeric pairs are defined here as mapping to different chromosomes or in the wrong orientation.

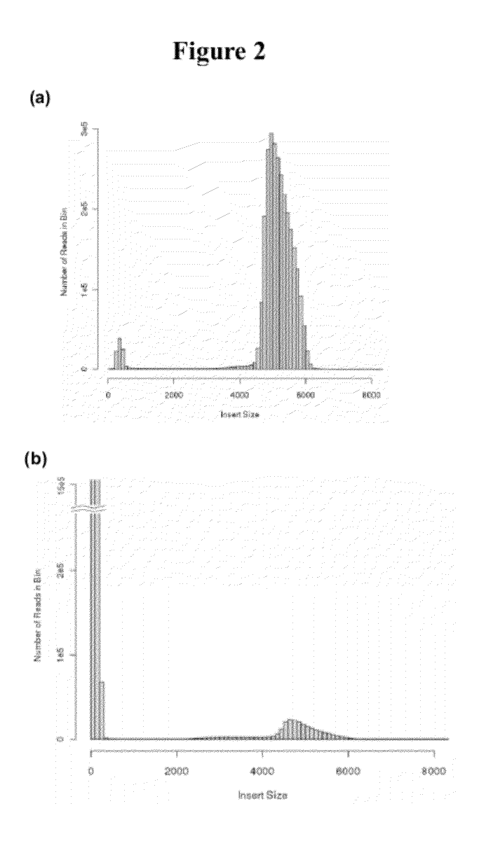

From Table 1, we see that the CLIP-PE approach yielded 20.6% informative pairs with the expected insert size (around 5 kb) compared to 8.7% from Illumina's jumping library. As with all the percentage calculations in this text, we will be dividing by the number of mapped paired reads and not the total number of reads since this will help normalize noise in the libraries like error rates and other variables affecting library quality. FIG. 2 shows clearly that even though the Illumina's jumping library had a high percentage of uniquely mapped informative pairs, most of them [91%=(4,732,244−437,448)/4,732,244] were derived from small fragments (<600 bp) whereas CLIP-PE had only 11% [(6,329,048−5,642,986)/6,329,048] that were too small. The higher percentage of good mate pairs in our CLIP-PE library is also reflected by higher clone coverage of the genome which can be defined as the average number of read pairs that span any given nucleotide in the reference. The average clone coverage of CLIP-PE versus Illumina's jumping library is 4,746× and 18×, respectively (Table 7). The Illumina jumping library also had 31,602 bases that were in gaps compared to CLIP-PE's 55 bases. Lastly, the chimeric rate for CLIP-PE, at 2.3%, is better than the jumping method, 9.2% (Table 1).

### CLIP-PE Method can Consistently Generate High Quality Mate Pair Libraries

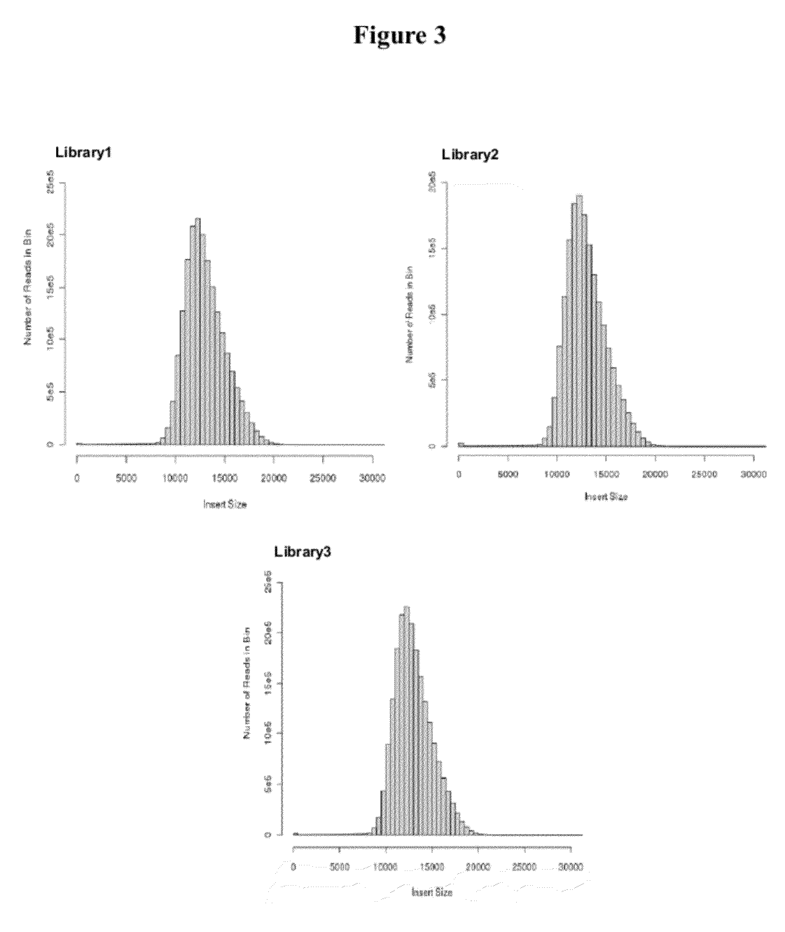

To test the CLIP-PE method with larger insert sizes, we made three Saccharomyces cerevisiae 12 kb libraries (Table 2 and FIG. 3). Table 2 shows that the three 12 kb libraries were of high quality and highly reproducible. For instance, averages of 59% of the mapped paired reads were unique informative pairs with the expected insert size. Roughly 5-7% of total reads mapped to different chromosomes and less than 0.05% mapped in the wrong orientation. We also successfully created three 22 kb libraries from S. cerevisiae genomic DNA (Table 3) and these will be discussed more in the next session.

### Ligation Efficiency Affects the Productivity and Quality of CLIP-PE Libraries

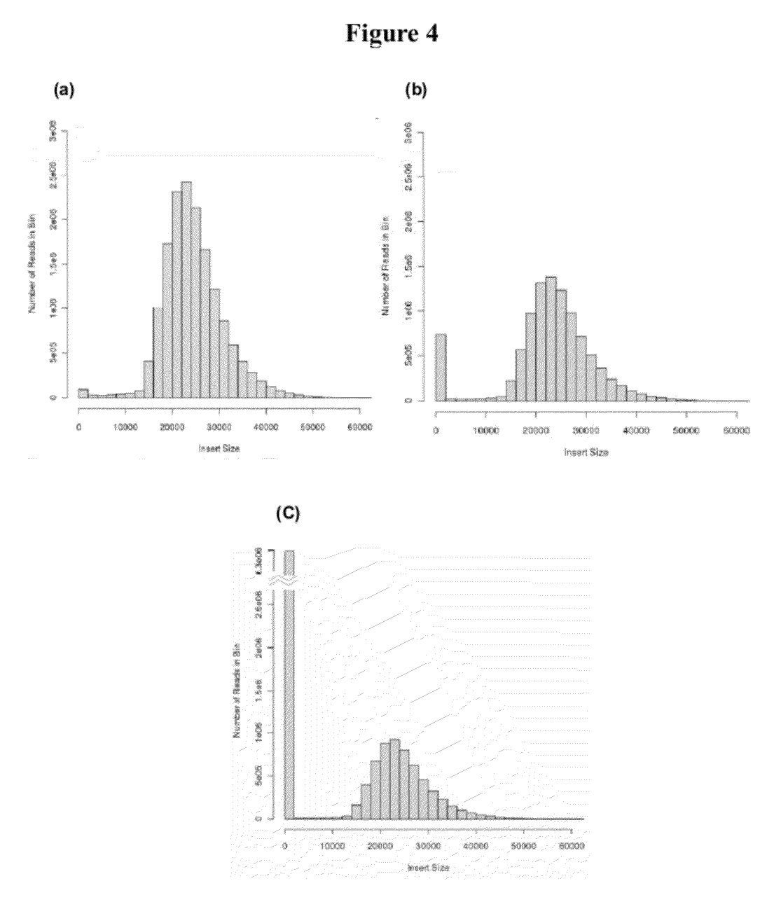

During the CLIP-PE process, either random shearing or enzyme cutting can be used for the secondary fragmentation after Cre circularization. To see the effects on ligation efficiency, we compared the two methods of fragmentation during the creation of three 22 kb S. cerevisiae CLIP-PE libraries. Restriction digestion was used for two libraries and random shearing for the third. Only 4 base cutting enzymes that had no cutting site in the P1-LoxP-P2 fragment were used. Two different 4 bp restriction enzymes were selected, from which, NlaIII generated 4 bp overhangs and HpyCH4IV generated 2 bp overhangs. Judging by the proportion of informative pairs, the NlaIII library was the most efficient (11.1% informative) followed by the 2 bp overhang, HpyCH4IV library (4.0%) and finally the blunt end, randomly sheared library (2.5%) (Table 3). This result is expected since self ligation with 4 bp overhang is more efficient than 2 bp overhang which is more efficient than blunt end. FIG. 4 clearly shows that the proportion of read pairs with short insert sizes increases as the size of the overhang gets smaller. All libraries had low (˜1.5-1.7%) chimeric pairs (Table 3) and almost no gaps in clone coverage (Table 9).

Genome Assemblies are Significantly Improved by Combining Short Illumina Reads with Long Paired End Reads Generated by the CLIP-PE Method

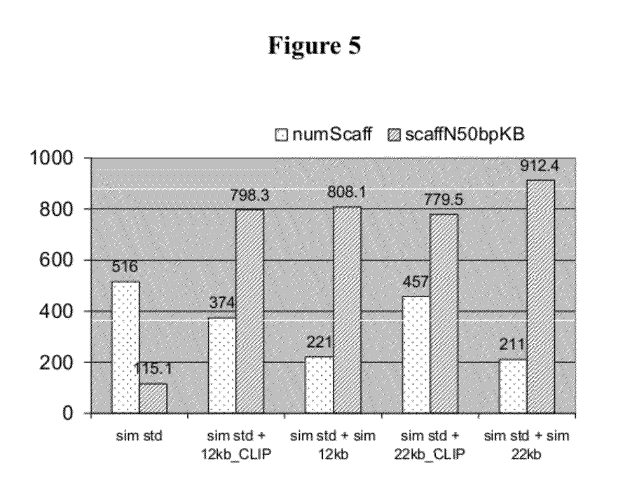

By combining standard Illumina short insert reads in addition to large insert mate-pair reads, repetitive regions can be resolved during assembly. We tested if 12 kb or 22 kb S. cerevisiae CLIP-PE libraries helped with the genome assembly when combined with short insert (250 bp) simulated 2×76 bp data. In addition to our 12 and 22 kb CLIP-PE libraries, we made simulated mate pair libraries of the same insert lengths as a comparison. The combinations used for assembly were: (1) simulated standard Illumina 250 bp library alone; (2) simulated standard plus simulated 12 kb; and (3) simulated standard plus simulated 22 kb mate pair library; (4) our CLIP-PE libraries in place of the simulated 12 kb and 22 kb libraries. Four criteria were used to assess final assemblies: (1) number of bases assembled; (2) the N50 scaffold and contig size; (3) the number of scaffolds and contigs (FIG. 5 and Table 10); and (4) the number of mis-assemblies (Table 4). The results did not show a significant difference in the number of assembled bases for any given assembly (11.6-12.3 MB) which is near the expected genome size of S. cerevisiae (12.2 MB). However, assemblies using CLIP-PE libraries greatly improved scaffold size when compared to the simulated standard alone. For example, the standard only assembly had an N50 scaffold size of 115.1 kb whereas the hybrid assemblies using our CLIP-PE libraries had scaffold N50 values of 798.3 kb (12 kb) and 779.5 kb (22 kb). This 7-fold jump in the N50 value is comparable to the scaffold N50 of the simulated hybrid assemblies. The number of scaffolds decreases from 516 to 374 in the CLIP-PE 12 kb+standard assembly and 516 to 457 for the CLIP-PE 22 kb+standard assembly. Values for the number of mis-assemblies including relocations, translocation, and inversions are reasonably similar (Table 4). Overall, results are comparable between contigs assembled using CLIP-PE or the simulated mate-pair reads, suggesting that CLIP-PE library quality is very high. Our CLIP-PE libraries of other microbes have consistently shown to help genome assembly and finishing (data not shown).

### Discussion

Next-generation sequencing technologies (NGS) produce huge amounts of data but the short read length (˜100 bp as compared to the ˜700 bp in the capillary method) presents a problem when trying to assemble the reads, especially of long repeat and duplicated regions of the genome. To overcome these problems, de novo genome assemblies require large insert, mate pair libraries. Since the Cre-LoxP system can circularize greater than 90 kb DNA fragments with high efficiency (Sternberg, N., Proc Natl Acad Sci USA 87, 103-7 (1990)), we employ the Cre-LoxP recombination rather than ligation used in Illumina jumping method to circularize gDNA fragments. Although some larger insert libraries such as fosmid, PAC or BAC can generate large insert paired ends, they are all constructed in vivo, which is clone based, therefore resulting in limited library complexity. In our experience, libraries made through Cre-loxP system not only produce more paired-end reads than ligation based method, but also have potential to make larger (>20 kb) insert size mate pair libraries to replace those in vivo methods.

5 kb H. turkmenica CLIP-PE libraries has fewer percentage of reads in non-redundant pairs than S. cerevisiae's 12 kb libraries, 23.1% versus 59%. These are two non-parallel experiments carried out in two different times. 5 kb H. turkmenica library was constructed by using less Cre-loxP reactions (one versus four for 12 kb S. cerevisiae library). In addition, the 5 kb H. turkmenica CLIP-PE library was generated prior to the optimization of Cre recombination and the inverse PCR steps that were implemented in S. cerevisiae's CLIP-PE libraries. Most likely, these reasons contribute to the high redundancy of 5 kb H. turkmenica CLIP-PE library. It has to be noticed that as the size of DNA molecule increases, the recombination efficiency of Cre-LoxP system seems decreased. This is probably one of the reasons causing the low complexity of 22 kb library comparing to the 12 kb libraries, (11.2% of reads in non-redundant pairs versus ˜59%), not neglecting less input molecules of larger fragment with same mass of DNA in circularization step.

Utilizing an inverse PCR strategy in our CLIP-PE procedure brings us several benefits. Current paired-end library generation methods from 454 and SOLiD (downloadable from the appliedbiosystems.com/cros/groups/mcb_support/documents/generaldocuments/cms_{—}081746 website) involve two ligation steps, where linkers and sequencing adapters are separately ligated after the first and second fragmentation of DNA. For both ligation steps, only molecules with the correct combination of linkers and adapters will result in useful products. By integrating Illumina amplification adapter P1 and P2 with LoxP sequence (FIG. 1), our CLIP-PE method needs only one ligation step that requires correct DNA molecule and adapter combination, resulting in a higher yield and complexity of the final library. This strategy also simplifies the procedure, since no modification (i.e., end repair) of the DNA molecule is necessary for self-ligation after the 2^{nd} fragmentation. Only the recombined DNA fragments with P1-LoxP-P2 structure can be amplified after self-ligation. The CLIP-PE strategy provides an efficient way to enrich the desired DNA fragments with two ends of original large DNA molecules brought together by recombination.

The Illumina mate pair library protocol utilizes self-ligation to bring two ends of a large DNA fragment together without a linker or recognizable sequence pattern. After sequencing, the junction point of the two ends cannot be identified. Thus, Illumina recommends the sequencing read length as short as 36 bp to prevent the risk of reading through the junction site which will result in chimeric reads. Our CLIP-PE procedure allows us to identify the junction site since the site is the same as the restriction site of the enzyme used. By trimming reads after first restriction site, chimeric reads can be avoided. This makes sequencing longer reads (2×76 bp or more) possible and will greatly aid in downstream data analysis and assembly. Alternatively, linkers can be used to identify junction sites as in 454 and SOLiD library generation methods. Our results indicated that this approach was not as effective as using enzyme cutting method, probably due to low ligation efficiency (data not shown). Additionally, since ends with 4 bp overhangs have higher ligation efficiency than the blunt ends, we get more than four-fold (11.1%/2.5%) increase in informative mate pair reads and 26-fold [(5.1%−2.5%%)/(11.2%−11.1%)] less non-specific background (i.e.: fragments less than 600 bp). Because enzyme cutting sites may not be evenly distributed throughout the genome, there may be concerns about potential gaps in genome coverage when using a restriction enzyme in the second fragmentation step. Our method randomly shears the genomic DNA in the first fragmentation step and the potential non-randomness of the restriction digestion in the second fragmentation step will be compensated for by the depth of randomly sheared fragments. In rare cases, where restriction enzyme cutting sites are very unevenly distributed, for example, in extreme high or low GC genomes, combining reads from libraries of two or more enzymes would most likely eliminate such coverage bias. There are many 4 bp enzymes available for the CLIP-PE second fragmentation step (Table 6). So far, even with one enzyme (NlaIII), we did not detect any bias in clone representation for six genomes with variable GC content ranging from 28% to 74% (data not shown).

The unique features of large mate pair libraries created by the CLIP-PE method deliver unmatched benefits. Compared to the Illumina jumping method, it generates a higher number of mate-paired reads with the desired insert size. Combined with a standard shotgun library, CLIP-PE will streamline de novo genome assembly and the finishing process. It also has prospects for genomic analysis such as structural variation detection especially for large complex genomes (Newman, T. L. et al., Genome Res 15, 1344-56 (2005)). Furthermore, the CLIP-PE strategy is versatile and can be widely applicable to other next-generation sequencing platforms.

### Methods

### Illumina Library Preparation

Illumina standard shotgun libraries were created with commercial Illumina Pair-end kit using 1 ug of genomic DNA without PCR amplification. Illumina jumping libraries were created with commercial Illumina's Mate-pair library preparation kit V2 with 5 ug genomic DNA.

### CLIP-PE Library Preparation

CLIP-PE libraries were prepared as follows: (i) 5, 15 or 30 ug of genomic DNA in 150 ul of EB buffer was sheared (Genomic Solutions, HydroShear) to a desired size: 5 kb, 12 kb, or 22 kb, respectively; (ii) 5 ul each of T4 DNA polymerase (New England Biolabs (NEB) M0203), Klenow enzyme (NEB, M0210L) and T4 Polynucleotide Kinase (NEB, M0201) and dNTP (NEB, N0447L) (400 uM final), BSA (0.1 ug/ul final) were used to repair the ends in 200 ul volume of 1×TNK buffer for 20 minutes at 25° C.; (iii) after end repair, 1.5 volume of Genfind v2 beads (Agencourt, A41499) were used to purify DNA according the manufacturer's guide, DNA was eluted with 40 ul EB; (iv) 2.5 ul of each loxP-P1 and loxP-P2 integrated adapters (20 uM) were ligated to the ends of DNA with 5 ul/100 ul of Quick ligase (NEB, M2200) for 15 minutes at 25° C.; (v) for 5 and 12 kb library, adapter ligated DNA was size selected through regular gel electrophoresis [1×TAE, 0.8% Ultrapure agarose (Invitrogen, 16500100), 0.6v/cm, overnight] and purified with Wizard® SV Gel and PCR Clean-Up System (Promega, A9281); for 22 kb library, the DNA was size selected with Pulse-Field gel electrophoresis (PFGE, 0.5×TBE, 1% Ultrapure agarose, 6 v/cm, 120°, 0.1-7 s pulse, 14° C., 11 hrs), DNA fragment was cut with out dye staining and electro-eluted (6V/cm, 90 min, reverse current 20 seconds) in dialysis bags (Sigma-Alorich, D0405) and concentrated to 40 ul volume by YM-100 columns (Millipore, 42412) by 500×g centrifugation, dilute with 250 ul of EB and concentrated to 40 ul volume again; (vi) DNA was filled-in with 24 u of Bst DNA polymerase (NEB, M0275) and dNTP (800 uM final) in 50 ul volume for 15 minutes at 50° C. and quantified by Qubit dsDNA BR kit (Invitrogen, Q32850); (vii)1-4 of loxP-Cre reactions (300 ng DNA/2 u Cre-recombinase/100 ul) were set up for 45 minutes at 37° C.; then 10 minutes at 70° C.; linear DNA was digested away by adding ATP (1 mM final) and 2 u/100 ul of Plasmid-Safe™ ATP-Dependent DNase (Epicentre, E3101K) and incubate 30 minutes at 37° C. then 30 minutes at 70° C., followed by EtOH precipitation purification; (viii) the circularized DNA was digested by 10 u/50 ul of NlaIII (NEB, R0125) for 1-2 hour at 37° C. and heat inactivation 20 minutes at 65° C.; (ix) ATP, T4 ligase buffer and T4 ligase (NEB, M0202) were added directly to the digestion reaction (adjust DNA concentration to 1 ng/ul, ATP 1 mM final, 1 ul T4 ligase/20 ul volume) to self-ligate of DNA fragments at room temperature for 1 hr or 14° C. overnight; (x) Optional: add Plasmid-Safe™ ATP-Dependent DNase (1 u/100 ul) directly to the self ligation solution to digest away linear DNA (xi) the ligation product was purified by EtOH precipitation or Streptavidin beads (Invitrogen Dynabeads® M-270 Streptavidin) according to the manufacturer's guide (xii) inverse PCR with Illumina pair-end library primers and Phusion Hot start II DNA Polymerase (NEB) were used to amplify the molecules containing the mate-pair ends only. (xiii) The PCR products were purified with gel electrophoresis, (1×TAE, 1.5% agarose 5V/cm, 60 min.) Gel piece containing 300-700 bp DNA fragments was extracted using a Wizard SV column. Adaptors may be annealed by dissolving each primer with TE0.1 buffer, mixing 10 ul of top and 10 ul of bottom primer with 30 ul of TE0.1/50 mM NaCl, and then using a thermocycler programmed as follows: 95° C. for 1 min, decrease temperature 0.1° C./second to 15° C. final temperature, then 14° C. forever.

### Illumina Sequencing

Sequencing was carried out according to the manufacturer's recommended protocols on a Genome analyzer II (GAIIx, Illumina, San Diego, Calif.). For standard Illumina PE libraries, a sequencing run was 2×100 cycles. All other sequencing runs were performed at 2×76 cycles.

### Post-Sequencing Analysis

To reduce the probability of a read crossing the junction point where the two distant ends of the original DNA fragment were joined during circularization, Illumina recommends reads no longer than 36 nucleotides when sequencing mate-pair libraries. Thus, we trimmed the sequencing results from Illumina jumping libraries to 35 bp. For Illumina standard shotgun library, we trimmed to 76 bp based on average quality scores for the data analysis. For CLIP-PE libraries, we trimmed bases after the enzyme cutting recognition site. All reads were aligned to the reference using the BWA aligner (Li, H. et al., Bioinformatics 25, 2078-9 (2009)). Fast and accurate short read alignment with Burrows-Wheeler transform (Zerbino, D. R. and Birney, E., Genome Res 18, 821-9 (2008)).

### Data Simulations and Genome Assembly

Simulated reads were generated from the reference using wgsim version 0.2.3 (Li, H. et al., Bioinformatics 25, 2078-9 (2009)) with a read length of 76 bp and an error rate of 1%. Datasets were assembled with velvet (Zerbino, D. R. and Birney, E., Genome Res 18, 821-9 (2008)). Various hash lengths (kmer lengths) were tested depending on the read length as well as varying the minimum number of pairs required to make a join. Libraries were specified as short pairs and an approximate insert size was given to velvet. Auto settings were used for the coverage cutoff and expected coverage variables. A minimum contig length of 200 bp was specified. Assembly accuracy was evaluated using dnadiff (found at gnu-darwin.org/www001/ports-1.5a-CURRENT/biology/mummer/work/MUMmer3.20/docs/dnadiff website) (Kurtz, S. et al., Genome Biol 5, R12 (2004)) to compare the assembly to the reference. Relocations are defined by dnadiff as “number of breaks in the alignment where adjacent 1-to-1 blocks are in the same sequence but not consistently ordered”. Translocations are where adjacent blocks are in different sequences and inversions are when the blocks are inverted.

TABLE 1
Results from the alignment of Haloterrigena turkmenica VKM,
DSM 5511 5 kb mate pair libraries made with CLIP-PE method
and Illumina Jumping method to the reference genome

| | | CLIP | | Jumping | |
|---|---|---|---|---|---|
| Description | | Values | Percent | Values | Percent |
| Total reads | | 33239176 | | 22106052 | |
| Mapped paired reads | | 27347728 | | 5020410 | |
| Unambiguously mapped | | 27028366 | 98.8% | 4978390 | 99.2% |
| paired reads | | | | | |
| Reads in informative pair | | 6329048 | 23.1% | 4732244 | 94.3% |
| Reads in informative pair | | 5642986 | 20.6% | 437448 | 8.7% |
| and >600 bp | | | | | |
| Chimeric | Map to different | 538004 | 2.0% | 33028 | 0.7% |
| | chromosomes | | | | |
| | Wrong orientation | 91980 | 0.3% | 427056 | 8.5% |

| | | |
|---|---|---|
| Number of gaps | 7 | 767 |
| Mean gap size (bp) | 8 +/− 13 | 41 +/− 133 |

Percentages are calculated by dividing by “Mapped Paired Reads”. Informative pairs map unambiguously to the reference and are de-replicated.

TABLE 2
Results from the alignment of Saccharomyces cerevisiae Illumina 12kb CLIP-PE
libraries to the reference genome

| | | Library 1 | | Library 2 | | Library3 | |
|---|---|---|---|---|---|---|---|
| Description | | Values | Percent | Values | Percent | Values | Percent |
| Total reads | | 74789134 | | 67341574 | | 79458906 | |
| Mapped paired reads | | 67120758 | | 59335508 | | 69864792 | |
| Unambiguously mapped | | 50784982 | 75.7% | 44680512 | 75.3% | 53095212 | 76.0% |
| paired reads | | | | | | | |
| Reads in informative pair | | 39696694 | 59.1% | 34717654 | 58.5% | 41471704 | 59.4% |
| Reads in informative pair and | | 39666120 | 59.1% | 34662488 | 58.4% | 41436998 | 59.3% |
| >600bp | | | | | | | |
| Chimeric | Map to different | 3627494 | 5.4% | 3999848 | 6.7% | 4553416 | 6.5% |
| | chromosomes | | | | | | |
| | Wrong orientation | 20680 | 0.0% | 22050 | 0.0% | 27360 | 0.0% |

| | | | |
|---|---|---|---|
| Number of gaps | 26 | 26 | 24 |
| Mean gap size (bp) | 84 +/− 157 | 299 +/− 1268 | 65 +/− 112 |

Percentages are calculated by dividing by “Mapped Paired Reads”. Informative pairs map unambiguously to the reference and are de-replicated.

TABLE 3
Results from the alignment of Saccharomyces cerevisiae Illumina 22kb CLIP-PE
libraries to a reference genome

| | | NlaIII cut | | HpyCH4IV cut | | Random shearing | |
|---|---|---|---|---|---|---|---|
| | | (4bp overhang) | | (4bp overhang) | | (4bp overhang) | |
| Description | | Values | Percent | Values | Percent | Values | Percent |
| Total reads | | 45036914 | | 38287456 | | 41663612 | |
| Mapped paired reads | | 40760246 | | 24523852 | | 30241684 | |
| Unambiguously mapped | | 31789650 | 78.0% | 19898350 | 81.1% | 24834322 | 82.1% |
| paired reads | | | | | | | |
| Reads in informative pair | | 4573952 | 11.2% | 1076742 | 4.4% | 1545550 | 5.1% |
| Reads in informative pair and | | 4530782 | 11.1% | 974198 | 4.0% | 744022 | 2.5% |
| >600bp | | | | | | | |
| Chimeric | Map to different | 697566 | 1.7% | 361526 | 1.5% | 473038 | 1.6% |
| | chromosomes | | | | | | |
| | Wrong orientation | 6250 | 0.0% | 4658 | 0.0% | 5684 | 0.0% |

| | | | |
|---|---|---|---|
| Number of gaps | 27 | 27 | 25 |
| Mean gap size (bp) | 137 +/− 285 | 179 +/− 499 | 108 +/− 194 |

Percentages are calculated by dividing by “Mapped Paired Reads”. Informative pairs map unambiguously to the reference and are de-replicated.

TABLE 4
Mis-assembly numbers of Saccharomyces cerevisiae
Illumina 22 kb CLIP-PE libraries

| Assembly Library Type | Relocations | Translocations | Inversions |
|---|---|---|---|
| std + 12 kb_CLIP-PE | 29 | 10 | 10 |
| std + sim 12 kb | 31 | 8 | 0 |
| std + 22 kb_CLIP-PE | 46 | 7 | 0 |
| std + sim 22 kb | 52 | 7 | 2 |

“std” refers to standard Illumina 250 bp library;
“sim 12 kb” refers to simulated 12 kb mate pair library;
“sim 22 kb” refers to simulated 22 kb mate pair library.

TABLE 5A
Sequences of CLIP-PE adapter for Illumina sequencer

| | |
|---|---|
| Adapter A | Phos/CGATAACTTCGTATAATGTATGCTATACGAAGT |
| (Top) | TATACACTCTTT*CCCTACACGACGCTCTTCCGATCT |
| | (SEQ ID NO: 1) |
| Adapter A | AGATCGGAAGAGCGTCGTGTAGGGAAAGAGTGTATAAC |
| (Bottom) | TTCGTATAGCATACATTATACGAAGTTATCGACC |
| | (SEQ ID NO: 2) |
| Adapter B | AGATCGGAAGAGCGGTTCAGCAGGAATGCCGAGATAAC |
| (Top) | TTCGTATAATGTATGCTATACGAAGTTATGCACC |
| | (SEQ ID NO: 3) |
| Adapter B | Phos/GCATAACTTCGTATAGCATACATTATACGAAGT |
| (Bottom) | TATCTCGGCATT*CCTGCTGAACCGCTCTTCCGATCT |
| | (SEQ ID NO: 4) |

T*: biotin labeled Thymine (optional)
All oligonucleotides were purchased from IDT (Integrated DNA Technologies, Inc., Coralville, IA) with HPLC purification)

TABLE 5B
Sequences of CLIP-PE PCR primers

| | |
|---|---|
| IL_PEPCR | AATGATACGGCGACCACCGAGATCTACACTCTTTCCCTA |
| Primer1.0 | CACGACGCTCTTCCGATCT* (SEQ ID NO: 5) |
| IL_PEPCR | CAAGCAGAAGACGGCATACGAGATCGGTCTCGGCATTCC |
| Primer2.0 | TGCTGAACCGCTCTTCCGATCT* (SEQ ID NO: 6) |

T*: biotin labeled Thymine (optional)
Oligonucleotides were purchased from Illumina, Inc.

TABLE 6
Candidates of 4 bp restriction enzymes used for CLIP-PE

| Enzymes | Cutting sequence |
|---|---|
| FatI | ^{▾}CATG_{▴} |
| NlaIII | _{▴}CATG^{▾} |
| SetI | _{▴}ASST^{▾} |
| Tsp509I | ^{▾}AATT_{▴} |
| CviAII | C^{▾}AT_{▴}G |
| BfaI | C^{▾}TA_{▴}G |
| CviQI | G^{▾}TA_{▴}C |
| MseI | T^{▾}TA_{▴}A |
| HhaI | G_{▴}CG^{▾}C |
| HinP1I | G^{▾}CG_{▴}C |
| MspI | C^{▾}CG_{▴}G |
| HpaII | C^{▾}CG_{▴}G |
| HpyCh4IV | A^{▾}CG_{▴}T |
| TaqI | T^{▾}CG_{▴}A |
| BstUI | CG_{▴}^{▾}CG |
| CviKI-1 | RG_{▴}^{▾}CY |
| HpyCH4V | TG_{▴}^{▾}CA |
| PhoI | GG_{▴}^{▾}CC |
| RsaI | GT_{▴}^{▾}AC |

R:A or G; Y:C or T

TABLE 7
Detailed data of comparison of CLIP-PE with Jumping method

| 1 General Stats | CLIP | | Jumping | |
|---|---|---|---|---|
| Total reads | 33239176 | | 22106052 | |
| Genome size | 5440782 | | 5440782 | |
| Expected read coverage | 440 | | 293 | |
| Error rate | 0.38 +/− 0.72 | | 0.82 +/− 1.24 | |
| | Raw Values | Percent | Raw Values | Percent |
| 2 Alignment Data | | | | |
| Total mapped | 31075443 | | 11684476 | |
| Mapped paired reads | 27347728 | 100.0% | 4978390 | 100.0% |
| Unambiguously mapped paired reads | 27028366 | 98.8% | 4907288 | 98.6% |
| Reads in informative pairs | 6329048 | 23.1% | 4732244 | 95.1% |
| Reads in informative pair and >600 bp | 5642986 | 20.6% | 437448 | 8.8% |
| Map to different chromosomes | 538004 | 2.0% | 33028 | 0.7% |
| 3 Insert Data | | | | |
| Median insert size | 5206 | | 89 | |
| Inward (correct orientation) | 5551006 | 20.3% | 10392 | 0.2% |
| Outward (wrong orientation) | 76096 | 0.3% | 424852 | 8.5% |
| Same direction (wrong orientation) | 15884 | 0.1% | 2204 | 0.0% |
| 4 Clone Coverage | | | | |
| Covered bases | 5440727 | 100.0% | 5409180 | 99.4% |
| Uncovered bases | 55 | 0.0% | 31602 | 0.6% |

| | | |
|---|---|---|
| Mean gap size (bp) | 8 +/− 13 | 41 +/− 133 |
| Number gaps | 7 | 767 |
| Mean coverage | 6916.53 +/− 9135.93 | 20.28 +/− 16.82 |
| Median coverage | 4746 | 18 |

TABLE 8
Detailed data of three Saccharomyces cerevisiae 12kb CLIP-PE libraries

| | Library 1 | | Library 2 | | Library 3 | |
|---|---|---|---|---|---|---|
| 1 General Stats | | | | | | |
| Total reads | 74789134 | | 67341574 | | 79458906 | |
| Genome size | 12156677 | | 121556677 | | 12156677 | |
| Expected coverage | 443 | | 399 | | 471 | |
| Error rate | 0.12 +/− 0.40 | | 0.35 +/− 0.61 | | 0.15 +/− 0.45 | |
| | Raw Values | Percent | Raw Values | Percent | Raw Values | Percent |
| 2 Alignment Data | | | | | | |
| Total mapped | 72747885 | | 65366025 | | 76986174 | |
| Mapped paired reads | 67120758 | 100.0% | 59335508 | 100.0% | 69864792 | 100.0% |
| Unambiguously mapped | 50784982 | 75.7% | 44680512 | 75.3% | 53095212 | 76.0% |
| paired reads | | | | | | |
| Reads in informative | 39696694 | 59.1% | 34717654 | 58.5% | 41471704 | 59.4% |
| pairs | | | | | | |
| Reads in informative | 39542852 | 58.9% | 34521204 | 58.2% | 41277532 | 59.1% |
| pair and >600bp | | | | | | |
| Map to different | 3627494 | 5.4% | 3999848 | 6.7% | 4553416 | 6.5% |
| chromosomes | | | | | | |
| 3 Insert Data | | | | | | |
| Median insert size | 12475 | | 12441 | | 12477 | |
| Inward (correct | 39522172 | 58.9% | 34499154 | 58.1% | 41250172 | 59.0% |
| orientation) | | | | | | |
| Outward (wrong | 5370 | 0.0% | 5816 | 0.0% | 7134 | 0.0% |
| orientation) | | | | | | |
| Same direction (wrong | 15310 | 0.0% | 16234 | 0.0% | 20226 | 0.0% |
| orientation) | | | | | | |
| 4 Clone Coverage | | | | | | |
| Covered bases | 12154498 | 100.0% | 12148907 | 99.9% | 12155111 | 100.0% |
| Uncovered bases | 2179 | 0.0% | 7770 | 0.1% | 1566 | 0.0% |

| | | | |
|---|---|---|---|
| Mean gap size (bp) | 84 +/− 157 | 299 +/− 1268 | 65 +/− 112 |
| Number gaps | 26 | 26 | 24 |
| Mean coverage | 24155.28 +/− 27298.21 | 21216.49 +/− 24412.06 | 24443.76 +/− 27352.45 |
| Median coverage | 27873 | 24325 | 28827 |

TABLE 9
Detailed data of Saccharomyces cerevisiae CLIP-PE libraries made by Enzyme cutting
and Random Shearing

| | NlaIII cut (4bp | | HpyCH4IV cut (2bp | | Random shearing (blunt | |
|---|---|---|---|---|---|---|
| | overhang) (a) | | overhang) (b) | | end) (c) | |
| 1 General Stats | | | | | | |
| Total reads | 45036914 | | 38287456 | | 41663612 | |
| Genome size | 12156677 | | 12156677 | | 12156677 | |
| Expected coverage | 267 | | 227 | | 247 | |
| Error rate | 0.13 +/− 0.41 | | 0.17 +/− 0.52 | | 0.19 +/− 0.63 | |
| | Raw Values | Percent | Raw Values | Percent | Raw Values | Percent |
| 2 Alignment Data | | | | | | |
| Total mapped | 43718745 | | 32519983 | | 36819964 | |
| Mapped paired reads | 40760246 | 100.00% | 24523852 | 100.0% | 30241684 | 100.0% |
| Unambiguously mapped | 31789650 | 78.0% | 19898350 | 81.1% | 24834322 | 82.1% |
| paired reads | | | | | | |
| Reads in informative | 4573952 | 11.2% | 1076370 | 4.4% | 1545550 | 5.1% |
| pairs | | | | | | |
| Reads in informative | 4530782 | 11.1% | 974198 | 4.0% | 744022 | 2.5% |
| pair and >600bp | | | | | | |
| Map to different | 697566 | 1.7% | 360942 | 1.5% | 473038 | 1.6% |
| chromosomes | | | | | | |
| 3 Insert Data | | | | | | |
| Median insert size | 22854 | | 22672 | | 9331 | |
| Inward (correct | 4524532 | 11.1% | 969540 | 4.0% | 738338 | 2.4% |
| orientation) | | | | | | |
| Outward (wrong | 1436 | 0.0% | 1220 | 0.0% | 1030 | 0.0% |
| orientation) | | | | | | |
| Same direction (wrong | 4814 | 0.0% | 3438 | 0.0% | 4654 | 0.0% |
| orientation) | | | | | | |
| 4 Clone Coverage | | | | | | |
| Covered bases | 12152990 | 100.0% | 12151847 | 100.0% | 12153968 | 100.0% |
| Uncovered bases | 3687 | 0.0% | 4830 | 0.0% | 2709 | 0.0% |

| | | | |
|---|---|---|---|
| Mean gap size (bp) | 137 +/− 285 | 179 +/− 499 | 108 +/− 194 |
| Number gaps | 27 | 27 | 25 |
| Mean coverage | 28065.71 +/− 17972.09 | 16021.82 +/− 9785.67 | 10353.52 +/− 6606.41 |
| Median coverage | 34334 | 19873 | 13429 |

TABLE 10
Detailed assembly metrics with simulated or real Illumina standard 250bp gDNA
library and Saccharomyces cerevisiae Illumina CLIP-PE libraries

| Assembly Library | Num | | Total Scaff | ScaffN50 | ScaffN50 bp | CtgN50 | CtgN50 bp |
|---|---|---|---|---|---|---|---|
| Type | Scaff | Num Ctg | (MB) | num | (KB) | num | (KB) |
| sim std | 516 | 612 | 11.6 | 36 | 115.1 | 43 | 93.7 |
| sim std + sim 12kb | 221 | 529 | 12 | 6 | 808.1 | 37 | 114 |
| sim std + 12kb CLIP | 374 | 803 | 11.8 | 6 | 798.3 | 64 | 57.1 |
| std + sim 12kb | 283 | 611 | 12 | 6 | 803.5 | 43 | 86.3 |
| std + 12kb CLIP | 645 | 1251 | 11.8 | 7 | 720.2 | 121 | 28.3 |
| sim std + sim 22kb | 211 | 625 | 12.3 | 6 | 912.4 | 38 | 105.9 |
| sim std + 22kb CLIP | 457 | 767 | 11.8 | 6 | 779.5 | 51 | 74.3 |
| std + sim 22kb | 267 | 620 | 12 | 6 | 830.5 | 42 | 93.8 |
| std + 22kb CLIP | 509 | 994 | 11.9 | 7 | 720.5 | 87 | 43.1 |

sim: simulated;
std: standard;
scaff: scaffold;
ctg: contig;
num: number

It is understood that the examples and embodiments described herein are for illustrative purposes only and that various modifications or changes in light thereof will be suggested to persons skilled in the art and are to be included within the spirit and purview of this application and scope of the appended claims. All publications, sequence accession numbers, patents, and patent applications cited herein are hereby incorporated by reference in their entirety for all purposes.

What is claimed is:

1. A method for making a mate-pair library, the method comprising:
a) fragmenting target DNA, thereby generating fragmented target DNA fragments;
b) size-selecting the fragmented target DNA, thereby generating size-selected DNA;
c) ligating a forward adaptor oligonucleotide and a reverse adaptor oligonucleotide to the size-selected DNA, wherein the forward adaptor oligonucleotide comprises a recombinase recombination site and a forward primer binding site and the reverse adaptor oligonucleotide comprises a recombinase recombination site and a reverse primer binding site, thereby generating adaptor-ligated size-selected DNA comprising ligated adaptor oligonucleotides at both ends of the fragments, wherein:
the recombinase recombination site in the forward adaptor oligonucleotide, when ligated to the size-selected DNA, is distal to the size-selected DNA relative to the forward primer binding site;
the recombinase recombination site in the reverse adaptor oligonucleotide, when ligated to the size-selected DNA, is distal to the size-selected DNA relative to the reverse primer binding site;
the recombinase recombination sites are oriented in the adaptor-ligated size-selected DNA such that, when contacted with a recombinase, one of the recombinase recombination sites is excised and the adaptor-ligated size-selected DNA is circularized; and
the primer binding sites are oriented in the adaptor-ligated sized-selected DNA such that, after recombination, second fragmentation and recircularization, the forward and reverse primer binding sites are oriented toward each other so the amplification can occur;
d) removing the nick between DNA fragment and adapter;
e) contacting the adaptor-ligated size-selected DNA with the recombinase to form circularized DNA comprising the forward and reverse primer sites in opposing directions and separated by a recombinase recognition/recombination site;
f) removing non-circularized DNA from the circularized DNA or digesting the non-circularized DNA;
g) fragmenting the circularized DNA, thereby generating linear DNA fragments comprising the forward and reverse primer sites in opposing directions flanked by target DNA;
h) self-ligating the linear DNA fragments, thereby forming re-circularized DNA comprising the forward and reverse primer sites; and
i) amplifying the re-circularized DNA with the forward and reverse primer, thereby forming a mate-pair library.

2. The method of claim 1, wherein the recombinase is a Cre recombinase and the recombinase recombination sites are lox sites.

3. The method of claim 1, wherein the fragmenting (step g) comprises cutting the circularized DNA with a restriction enzyme.

4. The method of claim 3, wherein the recognition sequence of the restriction enzyme is four contiguous base pairs.

5. The method of claim 1, wherein the fragmenting (step g) comprises random shearing.

6. The method of claim 5, wherein ends of the linear DNA fragments generated in step g are treated to generate blunt ends.

7. The method of claim 1, wherein the amplifying (step i) comprises a polymerase chain reaction (PCR).

8. The method of claim 1, further comprising sequencing the mate-pair library.

9. The method of claim 8, further comprising aligning or assembling from data generated from sequencing.

10. The method of claim 9, wherein the fragmenting (step g) comprises cutting the circularized DNA with a restriction enzyme, before aligning or assembling, determining the location of the recognition sequence of the restriction enzyme in sequencing reads and trimming the bases beyond the recognition site to avoid chimeric read.

11. The method of claim 1, wherein, following the fragmenting (step a), and before the ligating (step c), ends of the fragmented target DNA are treated to generate blunt ends.

12. The method of claim 1, wherein the target DNA is genomic DNA.

13. The method of claim 1, wherein the fragmented target DNA is size-selected for DNA at any range up to 90 kb.

14. A mate-pair library as generated in claim 1.

15. A mate-pair library as generated in claim 4, characterized in that each member of the library comprises one or more recognition sequences of one or more restriction enzymes.


SEQUENCE LISTING (6 sequences)

SEQ ID NO: 1 - DNA, 69 bp, Artificial Sequence
  CLIP-PE adapter for Illumina sequencer, Adapter A (top)
cgataacttcgtataatgtatgctatacgaagttatacactctttccctacacgacgctcttccgatct

SEQ ID NO: 2 - DNA, 72 bp, Artificial Sequence
  CLIP-PE adapter for Illumina sequencer, Adapter A (bottom)
agatcggaagagcgtcgtgtagggaaagagtgtataacttcgtatagcatacattatacgaagttatcgacc

SEQ ID NO: 3 - DNA, 72 bp, Artificial Sequence
  CLIP-PE adapter for Illumina sequencer, Adapter B (top)
agatcggaagagcggttcagcaggaatgccgagataacttcgtataatgtatgctatacgaagttatgcacc

SEQ ID NO: 4 - DNA, 69 bp, Artificial Sequence
  CLIP-PE adapter for Illumina sequencer, Adapter B (bottom)
gcataacttcgtatagcatacattatacgaagttatctcggcattcctgctgaaccgctcttccgatct

SEQ ID NO: 5 - DNA, 58 bp, Artificial Sequence
  CLIP-PE PCR primer, IL_PEPCR Primer1.0
aatgatacggcgaccaccgagatctacactctttccctacacgacgctcttccgatct

SEQ ID NO: 6 - DNA, 61 bp, Artificial Sequence
  CLIP-PE PCR primer, IL_PEPCR Primer2.0
caagcagaagacggcatacgagatcggtctcggcattcctgctgaaccgctcttccgatct